(19) United States
(12) Patent Application Publication
(10) Pub. No.: US 2003/0111251 A1
(43) Pub. Date: Jun. 19, 2003

(54) Method of producing an electrical cable insulating material

(75) Inventor: Yoko Arai, Yokkaichi-city (JP)

Correspondence Address: OLIFF & BERRIDGE, PLC, P.O. BOX 19928, ALEXANDRIA, VA, 22320, US

(73) Assignee: SUMITOMO WIRING SYSTEMS, LTD., Yokkaichi-city (JP)

(21) Appl. No.: 10/234,206

(22) Filed: Sep. 5, 2002

(30) Foreign Application Priority Data
Sep. 5, 2001 (JP) 2001-268583

(51) Int. Cl. H01B 1/00

(52) U.S. Cl. 174/68.1; 264/175; 264/176.1

(57) ABSTRACT

The present invention is directed to a method of producing a cable protecting material. The method can include mixing and kneading an olefin-type polymer and suitable additives to prepare an olefin-type polymer composition, transforming the composition into pellets, and extruding the pellets at a temperature of from about 190° C. to about 250° C. The cable protecting material has a smoothly flowing skin and a well balanced material distribution. The cable protecting material also has good wear resistance.

### BACKGROUND OF THE INVENTION

1. Field of Invention

The present invention is directed to a method of producing an electrical cable protecting material. In particular, the present invention is directed to a method of producing an olefin-type protecting material for electrical wires or cables.

2. Description of Related Art

Polyvinyl chloride has been widely used as a coating material for electrical cables used in vehicles, owing to its excellent mechanical strength, the ease with which it can be extruded around an electric cable, and its excellent flexibility, colorability (e.g., paintability) and cost efficiency.

However, due to recent global environmental measures, manufacturers of vehicle parts, including coatings of electrical cables for automobiles, have started to use halogen-free olefin-type polymers, such as olefin-type thermoplastic elastomers, instead of polyvinyl chloride. In particular, such halogen-free polymers are used as a base material, which is supplemented with a halogen-type flame-retardant such as a bromine-type flame retardant. See, for example, JP-A-5-320439, JP-A-10-195254, P2000-86563A, P2000-290439A, P2001-6447A.

When extruding compositions containing such olefin-type polymers, the surface of the products tends to become rough due to melt fractures, when the extrusion temperature is low. As a result, the wear resistance of the products is considerably lowered. Conversely, when the extrusion temperature is too high, material distribution is unbalanced and cooling-down deformations occur, thereby considerably reducing the lower limit of wear resistance.

### SUMMARY OF THE INVENTION

In view of these difficulties, it is an object of the present invention to provide a method for producing a protecting material for electrical cables used in wire harnesses and the like in vehicles. The resulting protecting material does not suffer from the problems mentioned above when, for example, producing tubes or sheets (ribbons) by extrusion.

Various exemplary embodiments of the method comprise the step of extruding an olefin-type polymer composition, such as an olefin-type thermoplastic elastomer composition, at temperatures ranging from about 190° C. to about 250° C.

In some such exemplary embodiments, the extruding step comprises extruding the composition at temperatures ranging from about 200° C. to about 220° C.

In various exemplary embodiments, the above method further comprises the step of mixing and kneading an olefin-type polymer and suitable additives, thereby obtaining pellets of the olefin-type polymer composition, the pellets being then supplied to the extruding step.

In various exemplary embodiments, the above extruding step comprises extruding an olefin-type polymer composition, such as an olefin-type thermoplastic elastomer composition, whose olefin-type polymer (or olefin moiety) has a JIS A hardness ranging from about 60 to about 95.

In various exemplary embodiments, the above extruding step comprises extruding an olefin-type polymer composition, such as an olefin-type thermoplastic elastomer composition, whose olefin moiety has 2 to 6 carbon atoms.

In various exemplary embodiments, the extruding step comprises extruding an olefin-type polymer composition, such as an olefin-type thermoplastic elastomer composition, whose olefin moiety is formed of propylene-ethylene-propylene copolymer.

In various exemplary embodiments, the above mixing and kneading step may comprise mixing and kneading, as the suitable additives, at least one agent selected from the group consisting of a bromine-type flame retardant, antimony trioxide, a heat stabilizer agent and a lubricant.

In some such exemplary embodiments, the mixing and kneading step may comprise mixing and kneading a bromine-type flame retardant in a proportion, such that the amount of bromine accounts for about 1 to about 10% by weight in the total amount of the olefin-type polymer composition.

In other exemplary embodiments, the mixing and kneading step may comprise mixing and kneading antimony trioxide in a proportion of at least about 0.5 parts by weight, relative to 100 parts by weight of olefin-type polymer.

In further exemplary embodiments, the mixing and kneading step may comprise mixing and kneading a heat stabilizer agent in a proportion of at least about 0.2 parts by weight, relative to 100 parts by weight of olefin-type polymer.

In still further exemplary embodiments, the mixing and kneading step may comprise mixing and kneading a lubricant in a proportion of at least about 0.2 parts by weight, relative to 100 parts by weight of olefin-type polymer.

The invention also relates to an electrical cable protecting material. In various exemplary embodiments, the material is prepared according to a method comprising the step of extruding an olefin-type polymer composition, such as an olefin-type thermoplastic elastomer composition, at temperatures ranging from about 190° C. to about 250° C.

In some such exemplary embodiments, the above material is prepared according to a method comprising the step of extruding an olefin-type polymer composition, such as an olefin-type thermoplastic elastomer composition, at temperatures ranging from about 200° C. to about 220° C.

The invention further relates to a tube or sheet made of an electrical cable protecting material. In various exemplary embodiments, the material is prepared according to a method comprising the step of extruding an olefin-type polymer composition, such as an olefin-type thermoplastic elastomer composition, at temperatures ranging from about 190° C. to about 250° C.

In some such exemplary embodiments, the above material is prepared according to a method comprising the step of extruding an olefin-type polymer composition, such as an olefin-type thermoplastic elastomer composition, at temperatures ranging from about 200° C. to about 220° C.

There is further provided a wire harness comprising a plurality of electrical cables, each electrical cable being coated with a tube or sheet made of an electrical cable protecting material. In various exemplary embodiments, the material is prepared according to a method comprising the step of extruding an olefin-type polymer composition, such as an olefin-type thermoplastic elastomer composition, at temperatures ranging from about 190° C. to about 250° C.

In some such exemplary embodiments, the above material is prepared according to a method comprising the step of extruding an olefin-type polymer composition, such as an olefin-type thermoplastic elastomer composition, at temperatures ranging from about 200° C. to about 220° C.

These and other features and advantages of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a schematic diagram showing a blade used for a scrape test; and

FIG. 2 is a schematic diagram showing the arrangement of the blade and a sample of olefin-type polymer composition, when a scrape test is carried out.

### DETAILED DESCRIPTION OF EXEMPLARY EMBODIMENTS

Olefin-type thermoplastic elastomer compositions, as an example of olefin-type polymer compositions, can be prepared and characterized as described below.

An olefin-type thermoplastic elastomer of the invention can contain olefin as its main component (i.e. accounting for at least 50% by weight of a repeating unit). The olefin can have a JIS A hardness ranging typically from 60 to 95 and in some embodiments from 70 to 93. The JIS A hardness is measured by a Durometer Type A, according to the method defined in Japanese Industrial Standards (JIS) K 7215 (pages 434 to 438).

Olefins having 2 to 6 carbon atoms, and some embodiments from 2 to 4 carbon atoms, such as ethylene, propylene and butylene, can be used.

The olefin-type thermoplastic elastomer may be a homopolymer or a copolymer. Further, the type of copolymer to be used is not particularly limited. In various exemplary embodiments, a propylene-ethylene-propylene copolymer can be used.

Examples of commercially available olefin-type thermoplastic elastomers include, but are not limited to, Catalloy KS-353P, Catalloy KS-081P, Catalloy KS-021P manufactured by Montell SDK Sunrise, and PER T310E manufactured by Tokuyama.

The type of bromine-based flame retardant to be used is not particularly limited for the purpose of the present invention. Bromine-type flame-retardants used for resins and rubbers can also be used in the invention. Suitable bromine-containing compounds usable as flame retardants include, but are not limited to, derivatives of tetrabromo-bisphenol A.

Examples of commercially available flame retardants include, but are not limited to, Fire Guard 3100 manufactured by Teijin Chemicals, Ltd. (bromine atom contents: 68% by weight) and Flame Cut 121R manufactured by Tosoh Co. Ltd. (bromine atom contents: 67% by weight).

A bromine-type flame retardant can be added such that the amount of halogen varies from about 1 to about 10% by weight, and in some embodiments from about 1.2 to about 5% by weight, of the total weight of olefin-type thermoplastic elastomer composition.

In some cases, when the amount of bromine-type flame retardant is less than the above lower limit, the composition does not procure a sufficient flame retardant property. Conversely, in some cases when the amount of bromine-type flame retardant is higher than the above upper limit, the specific gravity of the composition becomes too high, thereby preventing weight reduction of the composition.

Antimony trioxide can be added in a proportion of at least about 0.5 parts by weight, in some embodiments at least about 1 part by weight, relative to 100 parts by weight of olefin-type thermoplastic elastomer.

In some cases, when the content of antimony trioxide is less than about 0.5 parts by weight, the compound is not endowed with a sufficient flame retardant property. Though the amount of antimony trioxide in the compositions according to this invention has no particular upper limit, when added in excess, the specific gravity of the resulting composition can become too high.

In order to improve the thermal stability of the olefin-type thermoplastic elastomer composition, a heat stabilizer agent (oxidation- and aging-preventing agent) can be added. Examples of such heat stabilizer agent include, but are not limited to, hindered phenol-type anti-aging agents, monophenol-type anti-oxidants, bisphenol-type anti-oxidants, trisphenol-type antioxidants, polyphenol-type antioxidants, thiobisphenol-type antioxidants and phosphorous ester-type anti-aging agents.

Commercially available examples of such products include, but are not limited to, Tominox TT (hindered phenol-type anti-aging agent manufactured by Yoshitomi Finechemical Co. Ltd), Nocrack 200 (monophenol-type anti-aging agent manufactured by Ouchi Shinko Chemical Industrial Co. Ltd), Nocrack NS-6 (bisphenol-type anti-aging agent manufactured by Ouchi Shinko Chemical Industrial Co. Ltd) and Nocrack 300 (thiobisphenol-type anti-aging agent manufactured by Ouchi Shinko Chemical Industrial Co. Ltd).

A heat stabilizer agent can be added in a proportion of at least about 0.2 parts by weight, in some embodiments at least about 0.5 parts by weight, relative to 100 parts by weight of the olefin-type thermoplastic elastomer.

A lubricant can also be added in the olefin-type thermoplastic elastomer composition of the invention in order to improve its moldability. Such lubricants include, but are not limited to, fatty acids, metal salts thereof, amides thereof and the like.

The lubricant can be added in a proportion of at least about 0.2 parts by weight, in some embodiments at least about 0.5 parts by weight, relative to 100 parts by weight of olefin-type thermoplastic elastomer.

Further, any known additive, which is commonly used in elastomer compositions for wire harness parts material, may be added to the olefin-type thermoplastic elastomer composition of the invention. Examples of such additives include, but are not limited to, any kind of colorant and charge-preventing agent. The amount of additive may be determined as a function of its type.

In the present invention, the components or additives mentioned above may be mixed and kneaded according to any known method and transformed into pellets by means of a pelletizer. The obtained pellets may be extruded so as to obtain a protecting material. Conditions for kneading and pelletizing are not particularly limited. The same conditions as in the prior art can be used.

According to the method of the present invention, a composition can be extruded at a temperature ranging from about 190° C. to about 250° C., and in some embodiments, from about 200° C. to about 220° C. By regulating the composition temperature within the above ranges, the viscosity of the composition can be adjusted to a suitable range. As a result, the extruded material forms a smoothly flowing surface, free from unbalanced material distribution. The protecting material thus produced has an improved wear resistance.

### EXAMPLES

This invention is illustrated by the following Examples, which are merely for the purpose of illustration and are not to be regarded as limiting the scope of the invention, or the manner in which it may be practiced.

The compositions (E1 to E5) shown in Table 1 are prepared by mixing respective components in indicated amounts, and by kneading the components at a temperature of about 180° C. for about 10 minutes in a pressurized kneader (volume: 20 l). The compositions are then transformed into pellets using a pelletizer. The oxygen index (OI) of the pellets was measured according to JIS K 7201. Obtaining OI values allows for the evaluation of the flame-retarding properties of a composition. When OI is higher than 27, a composition is considered as good. The results of the OI evaluation are also shown in Table 1. Quantities are given in parts by weight, unless otherwise noted.

TABLE 1

| Components | E1 | E2 | E3 | E4 | E5 |
|---|---|---|---|---|---|
| Olefin-Type | 100 | 100 | 100 | 100 | 100 |
| Thermoplastic | | | | | |
| Elastomer¹ | | | | | |
| Bromine-Type Flame | 1.8 | 2.5 | 3 | 3.5 | 5 |
| Retardant² | | | | | |
| Antimony Trioxide³ | 0.9 | 1.3 | 1.5 | 1.8 | 2.5 |
| Heat Stabilizer | 1 | 1 | 1 | 1 | 1 |
| Agent⁴ | | | | | |
| Zinc Stearate⁵ | 0.5 | 0.5 | 0.5 | 0.5 | 0.5 |
| Calcium Stearate⁵ | 0.5 | 0.5 | 0.5 | 0.5 | 0.5 |
| Flame Retardaney | 27 | 27.5 | 28 | 29 | 31 |
| (OI) | | | | | |
| Halogen Content | 1.2 | 1.6 | 1.9 | 2.2 | 3.1 |
| (weight %) | | | | | |

In Table 1:
“E” denotes an Example of the present invention.
¹Olefin-type thermoplastic elastomer: CATALLOY KS-081P, manufactured by Montell SDK Sunrise.
²Bromine-type flame retardant: FIRE GUARD 3100, manufactured by Teijin Chemicals, Ltd. (68% by weight bromine).
³Antimony trioxide: manufactured by Mikuni Seiren Co., Ltd.
⁴Heat stabilizer agent: hindered phenol-type anti-aging agent, manufactured by Yoshitomi Fine Chemical Co., Ltd.
⁵Zinc Stearate: manufactured by Mizusawa Industrial Chemicals, Ltd. Examples 1 to 4 and Comparative Examples 1 to 4

The components of the Examples shown in Table 1 are mixed together in respective amounts, kneaded for about 10 minutes at a temperature of about 180° C. in a pressurized kneader (volume: 20 l), and transformed into pellets using a pelletizer. A wire-harness protecting tube (thickness: 0.3 mm; internal diameter: 10 mm) is formed by extrusion of the obtained pellets. The pellets are extruded in an extruder (diameter: 50 mm) at an extrusion (line speed) of 35 m/min. The temperatures of the composition (resin) during molding are shown in Tables 2 and 3.

The external aspect of the obtained product (extruded skin and material distribution) is evaluated.

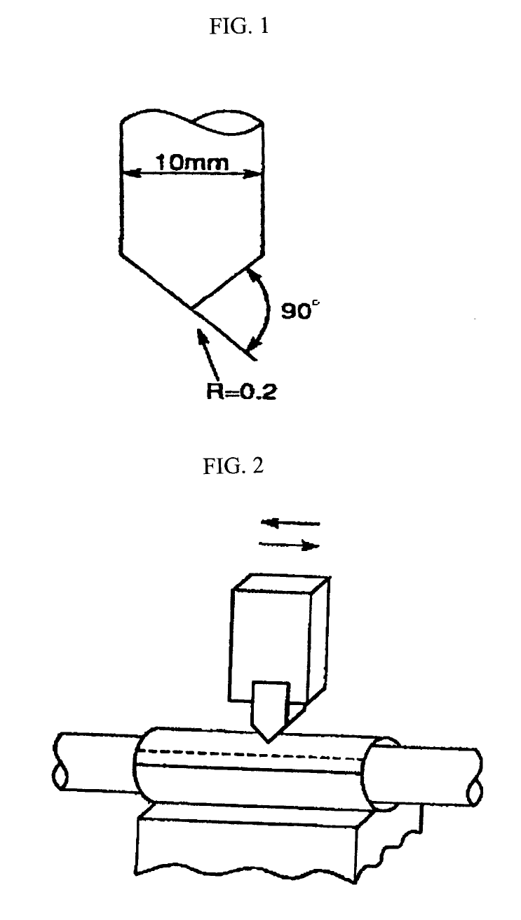

Wear resistance is measured by the following technique. As shown in FIG. 2, a blade made of a quenched steel (shown in FIG. 1) is reciprocated in order to impart a to-and-fro motion on the sample. A 10N force is applied by the blade. The blade is reciprocated at a rate of one to-and-fro motion/second at 23° C., with a reciprocation amplitude of 10 mm. The number of to-and-fro cycles until the complete abrasion and disappearance of the sample is recorded. A number in excess of 150 is considered a good result.

The tensile strength up to breaking point is measured according to the tensile-strength test of JIS K 6310. A value of 15.7 MPa is considered to be a good result. The results shown in Tables 2 and 3.

TABLE 2

| | E1 | E2 | E3 | E4 |
|---|---|---|---|---|
| Composition Temperature (° C.) | 190 | 210 | 230 | 250 |
| External Aspect | good | good | good | good |
| Wear Resistance | 250 | 270 | 230 | 250 |
| (number of to-and-fro cycles) | | | | |
| Tensile Strength (MPa) | 28.6 | 29.4 | 28.3 | 27.5 |

In Table 2:
“E” denotes Example.

TABLE 3

| | CE1 | CE2 | CE3 | CE4 |
|---|---|---|---|---|
| Composition Temperature (° C.) | 170 | 180 | 260 | 270 |
| External Aspect | bad | bad | bad | bad |
| Wear Resistance | 30 | 50 | 120 | 110 |
| (number of to-and-fro cycles) | | | | |
| Tensile Strength (MPa) | 14.9 | 15.1 | 20.5 | 19.7 |

In Table 3:
“CE” denotes Comparative Example.

When the composition (resin) temperature was lower than about 180° C. during extrusion, melt fractures appeared on the surface of the tube formed. When the temperature was higher than about 250° C., an unbalanced material distribution was formed.

The present application claims priority to Japanese Application No. 2001-268583, filed on Sep. 5, 2001, the disclosure of which is herein expressly incorporated by reference in its entirety.

While this invention has been described in conjunction with the specific embodiments above, it is evident that many alternatives, combinations, modifications, and variations are apparent to those skilled in the art. Accordingly, the exemplary embodiments of this invention, as set forth above are intended to be illustrative, and not limiting. Various changes can be made without departing from the spirit and scope of this invention.

What is claimed is:

1. A method of producing an electrical cable protecting material comprising extruding an olefin-type polymer composition at a temperature of from about 190° C. to about 250° C.

2. The method according to claim 1, wherein extruding the olefin-type polymer composition comprises extruding an olefin-type thermoplastic elastomer composition.

3. The method according to claim 1, wherein extruding the olefin-type polymer composition comprises extruding the olefin-type polymer composition at a temperature of from about 200° C. to about 220° C.

4. The method according to claim 1, further comprising mixing and kneading an olefin-type polymer and suitable additives to obtain pellets of the olefin-type polymer composition prior to extruding.

5. The method according to claim 3, further comprising mixing and kneading an olefin-type polymer and suitable additives to obtain pellets of the olefin-type polymer composition prior to extruding.

6. The method according to claim 1, wherein the olefin-type polymer composition comprises an olefin-type polymer having a JIS A hardness of from about 60 to about 95.

7. The method according to claim 1, wherein the olefin-type polymer composition comprises an olefin moiety having 2 to 6 carbon atoms.

8. The method according to claim 1, wherein the olefin-type polymer composition comprises an olefin moiety formed of a propylene-ethylene-propylene copolymer.

9. The method according to claim 4, wherein the suitable additives comprise at least one agent selected from the group consisting of a bromine-type flame retardant, antimony trioxide, a heat stabilizer agent and a lubricant.

10. The method according to claim 9, wherein the suitable additives comprise the bromine-type flame retardant in a proportion sufficient to yield the olefin-type polymer composition having from about 1 to about 10% by weight bromine.

11. The method according to claim 9, wherein mixing and kneading an olefin-type polymer and suitable additives comprises mixing and kneading the antimony trioxide in a proportion of at least about 0.5 parts by weight, relative to 100 parts by weight of the olefin-type polymer.

12. The method according to claim 9, wherein mixing and kneading an olefin-type polymer and suitable additives comprises mixing and kneading the heat stabilizer agent in a proportion of at least about 0.2 parts by weight, relative to 100 parts by weight of the olefin-type polymer.

13. The method according to claim 9, wherein mixing and kneading an olefin-type polymer and suitable additives comprises mixing and kneading the lubricant in a proportion of at least about 0.2 parts by weight, relative to 100 parts by weight of the olefin-type polymer.

14. An electrical cable protecting material, the material being prepared by extruding an olefin-type polymer composition at a temperature of from about 190° C. to about 250° C.

15. The electrical cable protecting material according to claim 14, wherein the material is prepared by extruding the olefin-type polymer composition at a temperature of from about 200° C. to about 220° C.

16. A tube or sheet made of an electrical cable protecting material, the material being prepared by extruding an olefin-type polymer composition at a temperature of from about 190° C. to about 250° C.

17. The tube or sheet according to claim 16, wherein the material is prepared by extruding the olefin-type polymer composition at a temperature of from about 200° C. to about 220° C.

18. A wire harness comprising a plurality of electrical cables, each electrical cable being coated with a tube or sheet made of an electrical cable protecting material, the material being prepared by extruding an olefin-type polymer composition at a temperature of from about 190° C. to about 250° C.

19. The wire harness according to claim 18, wherein the material is prepared by extruding the olefin-type polymer composition at a temperature of from about 200° C. to about 220° C.
